(19) United States
(12) Patent Application Publication
(10) Pub. No.: US 2025/0337250 A1
(43) Pub. Date: Oct. 30, 2025

(54) AC COUPLED CONTROLLER TO FACILITATE POWER FLOW BETWEEN GRID, POWER SOURCES, AND BUILDING

(71) Applicant: Ford Global Technologies, LLC, Dearborn, MI (US)

(72) Inventors: Timothy Harris, Grosse lle, MI (US); Haider Mhiesan, Canton, MI (US)

(21) Appl. No.: 18/644,666

(22) Filed: Apr. 24, 2024

(51) Int. Cl. H02J 3/46; H02J 3/32

(52) U.S. Cl. CPC H02J 3/46; H02J 3/322; H02J 3/381; H02J 3/388; H02J 2300/24

(57) ABSTRACT

A controller transitions from supply of power from a grid to a building to supply of power from one of a plurality of power sources to the building such that during the transition a rate of power supplied to the building remains constant, and after the transition satisfies demand for power from the building via more than the one of the power sources such that a rate power supplied by the one of the power sources decreases.

### TECHNICAL FIELD

This disclosure relates to power management for homes and other buildings.

### BACKGROUND

A home (or other building) energy system may include solar panels and other renewable energy sources, depending on the geographical and environmental context. Such a system may also include batteries, such as lithium-ion batteries, to store electricity generated from these renewable sources for use during periods of low production, like nighttime for solar energy. This stored energy is made usable through inverters, which convert direct current (DC) from the batteries into alternating current (AC), the form required for most appliances.

A connection to the traditional power grid ensures that homes can still draw energy when production from renewable sources and storage reserves are not enough. This may also allow homeowners to sell excess generated energy back to the grid, leveraging systems like net metering to offset issues further. Energy management systems are used to manage these various energy streams.

Energy management systems may include sensors that detect parameters related to the power being supplied and/or demanded.

### SUMMARY

An energy management system includes circuitry arranged to selectively transfer power between a grid, a plurality of power sources, and a building. The energy management system also includes a controller that transitions supply of power from the grid to the building to supply of power from one of the power sources to the building such that during the transition, a rate of power supplied to the building remains constant. The controller, after the transition, satisfies demand for power from the building via more than the one of the power sources such that a rate power supplied by the one of the power sources decreases.

A method includes commanding a grid and at least one of a plurality of power sources to concurrently satisfy demand for power from a building such that as the demand for power from the building changes, a rate of power supplied by the grid to the building remains constant and greater than zero.

An energy management control system includes a controller that satisfies a demand for power from a building via a grid and an electric vehicle such that as the demand for power from the building changes, a rate of power supplied by the grid to the building remains constant and greater than zero.

### BRIEF DESCRIPTION OF THE DRAWINGS

FIG. 1 is a schematic diagram of a power system using a grid to satisfy home power demand.

FIGS. 2 and 3 are schematic diagrams of the power system of FIG. 1 transitioning from grid power to other energy sources while continuing to satisfy the home power demand.

FIG. 4 is a schematic diagram of the power system of FIG. 1 redistributing supply among the other energy sources while continuing to satisfy the home power demand.

FIG. 5 is a schematic diagram of the power system of FIG. 1 maintaining supply of power from the grid constant while using the other energy sources to satisfy the home power demand.

FIG. 6 is a schematic diagram of the power system of FIG. 1 storing excess power generated by the other energy sources.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Home-based alternative energy sources and energy storage systems are becoming more common. The same can be used to support home power requirements. That is, these alternative sources and storage systems can be used in combination with, or instead of, grid power.

This disclosure proposes architectures and control strategies for facilitating power transfer between a grid, various alternative power sources (e.g., electric vehicles, solar panels, home energy storage systems, etc.), and a home or other building. The architectures can, for example, include an AC coupling system and an AC coupling controller. The control strategies can, for example, include synchronizing power sources with the grid at zero current, transitioning home supply from the grid to at least one of the power sources, redistributing supply among the power sources, operating the power sources such that power delivered from the grid remains constant, and shuttling excess power produced by one of the power sources to other of the power sources for storage.

Synchronizing power sources with a grid at zero current involves matching the voltage, frequency, and phase angle of the power source with those of the grid. The connection is initiated at a moment when the difference in phase angle between the grid and power source results in no instantaneous current flow. This may be an ideal scenario because it minimizes the transient currents that can occur when connecting a power source to the grid, which in turn reduces the stress on the electrical system and increases the system's reliability and lifespan.

The voltage magnitude of the power source should be equal to that of the grid when connecting them together. This ensures that no large current flows due to voltage difference at connection. Inverters play a role in voltage matching, especially in power sources that generate DC electricity, such as solar panels. These inverters can be designed to convert DC to AC and to adjust the output voltage to match the grid voltage responsive to corresponding commands. Maximum power point tracking (MPPT) may enable the inverter to maximize the power output from certain of the power sources (e.g., solar panels) by adjusting the voltage and current while converting it to AC. MPPT allows the power sources to operate at their optimal power point despite variations in sunlight and temperature. Inverters can further adjust their output voltage in response to grid voltage variations to adhere with grid standards based on monitoring the grid voltage and dynamically adjusting the output.

The power sources should operate at the same frequency and phase as the grid. Since the grid frequency reflects the balance between supply and demand, connecting a source with a different frequency can cause fluctuations and instability. Moreover, connecting a power source when its voltage waveform is 180 degrees out of phase with the grid, for example, would result in a high inrush current. The inverter may control the frequency and phase synchronization. Phase-locked loops (PLLs) can be used to lock onto the grid's frequency and phase. The PLL adjusts the inverter's output frequency and phase by changing the switching rate of the inverter's power electronic devices so that the output frequency and phase match the grid's frequency and phase. Algorithms within the inverter may continually monitor the grid and adjust the inverter's output to maintain synchronization. This may include dynamic adjustments to deal with slight variations in the grid frequency, which can occur due to changes in load or generation elsewhere on the grid.

The process of synchronization begins with detecting the grid's frequency, voltage, and phase angle using sensors and electronic measurement circuits. Based on this information, known control algorithms adjust the power electronic devices' output to match the grid. This involves adjusting the timing of the switching actions within the inverter or converter to, for example, shift the phase angle of the output power. Once the output is synchronized with the grid in terms of frequency, voltage, and phase angle, a switch or relay may connect the power source to the grid. Automatic synchronization relays may permit this connection to happen at the right moment. After connection, the system continuously monitors grid conditions and adjusts its output to maintain synchronization, adapting to any changes in grid frequency or voltage that might occur due to varying loads or generation elsewhere in the system.

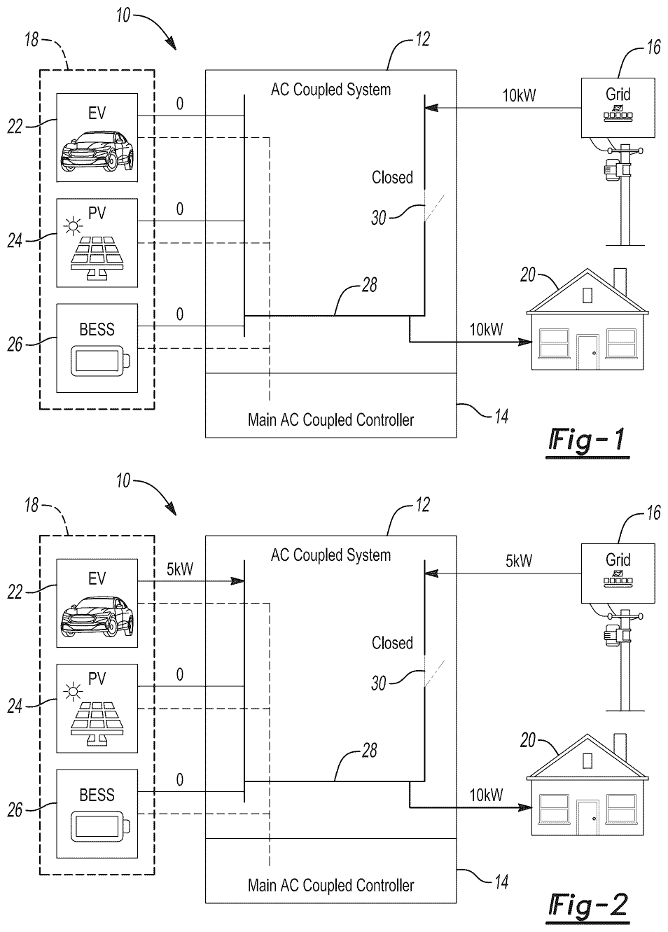

Referring to FIG. 1, an energy management system 10 includes an AC coupled system 12 and an AC coupled controller 14. The energy management system 10 is arranged to be connected with a grid 16 and other energy sources 18, and to supply energy to home 20. The AC coupled controller 14 is in communication with/exerts control over the other energy sources 18, which in this example include an electric vehicle 22, a solar power (photo voltaic) system 24 (solar panels, inverter), and battery (battery energy storage) system 26 (storage cells, inverter). The AC coupled system 12 includes circuitry 28 electrically connecting each of the other energy sources 18 and the home 20, and a switch 30 configured to selectively connect the grid 16 to the other energy sources 18 and home 20.

When the switch 30 is closed, power from the grid 16 may flow to the home 20. In this example, the home 20 is demanding 10 KW and the grid is supplying 10 kW. In preparation for sourcing some of the power to be supplied to the home 20 from the other energy sources 18, the AC coupled controller 14 synchronizes those of the other energy sources 18 that are to supply power to the home 20 with that of the grid 16. As mentioned above, the AC coupled controller 14 detects the frequency, voltage, and phase angle of power from the grid 16 via known sensors and electronic measurement circuits and commands inverters of those of the other energy sources 18 that are to supply power to the home 20 to adjust the timing of their switching actions to match the frequency, voltage, and phase angle of the power from the grid 16.

Referring to FIG. 2, the home 20 continues to demand 10 kW. The AC coupled controller 14, however, has reduced the supply of power from the grid to 5 kW and increased the power supplied from the electric vehicle 22 to 5 kW-continuing to satisfy the demand of the home 20. That is, while the AC coupled controller 14 reduced the power from the grid 16 via commands to the converter interfaced with the grid 16, it concurrently increased the power from the electric vehicle 22 via commands thereto so that the total amount of power being supplied to the home 20 remained the same.

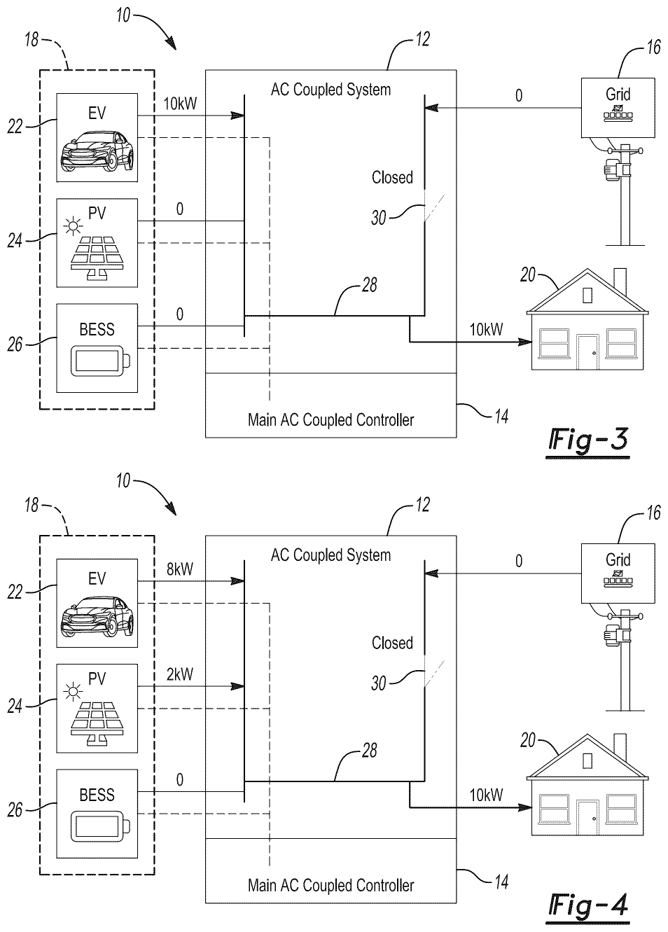

Referring to FIG. 3, the AC coupled controller 14 has reduced the supply of power from the grid to 0 KW and increased the power supplied from the electric vehicle 22 to 10 kW: The electric vehicle 22 is completely responsible for satisfying the power demanded by the home 20.

Referring to FIG. 4, the AC coupled controller 14 next redistributes the supply among the other energy sources 18. The AC coupled controller 14 commands the electric vehicle 22 to reduce the amount of power it is supplying and concurrently commands the solar power system 24 to increase the amount of power it is supplying so that the net power delivered to the home 20 remains unchanged. In this example, the AC coupled controller 14 commands the electric vehicle 22 to supply 8 kW and the solar power system 24 to supply 2 kW, which in total is sufficient to satisfy the 10 kW demand from the home 20.

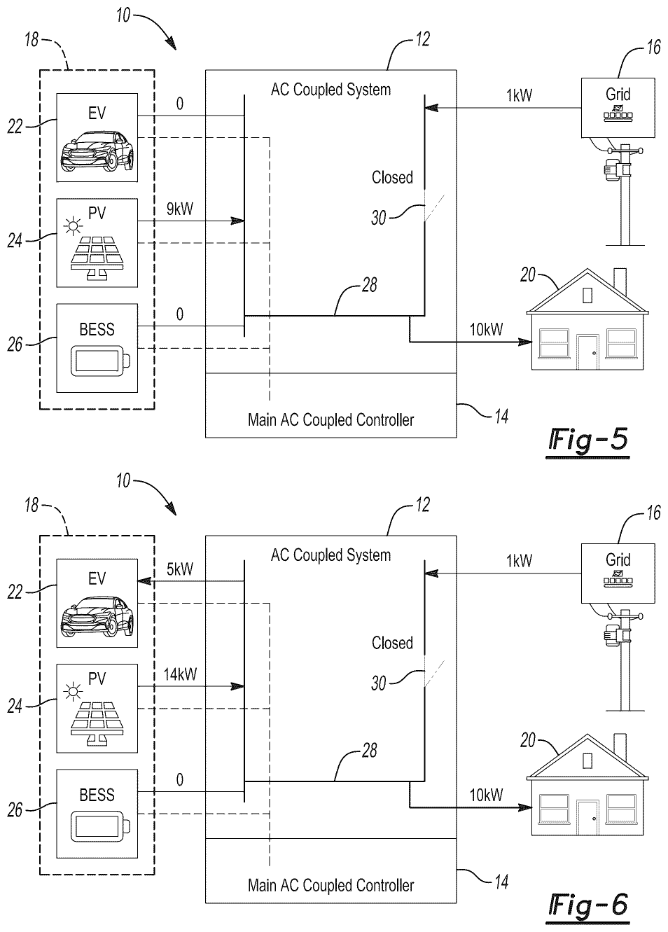

Referring to FIG. 5, the AC coupled controller 14 may maintain power supplied from the grid 16 at a constant value, regardless of the amount of power demanded by the home 20, and satisfy the balance of the power demanded by the home 20 via power from the other energy sources 18. The AC coupled controller 14 commands the converter interfaced with the grid 16 to, in this example, continuously supply 1 kW, even though the home 20 is demanding 10 kW. The AC coupled controller 14 makes up the difference between the home demand and the constant power being supplied by the grid 16 via the other energy sources 18. The AC coupled controller 14 commands the solar power system 24 to supply the difference (e.g., 9 KW). In this fashion, demand on resources from the grid 16 can be kept constant and additional power needed by the home 20 can be satisfied via the other energy sources 18.

Referring to FIG. 6, the solar power system 24 is producing more power than the home 20 requires. This can happen during peak sunny periods. The AC coupled controller 14 commands the electric vehicle 22 (or battery system 26) to store the excess power. Even while the other energy sources 18 are producing excess power, the AC coupled controller 14 maintains the power being supplied from the grid 16 steady. Alternatively, the AC coupled controller 14 may instead of pulling power from the grid 16, direct the excess power from the other energy sources 18 back to the grid 16.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials. “Controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An energy management system comprising:
circuitry arranged to selectively transfer power between a grid, a plurality of power sources, and a building; and
a controller programmed to transition from supply of power from the grid to the building to supply of power from one of the power sources to the building such that during the transition a rate of power supplied to the building remains constant, and after the transition to satisfy demand for power from the building via more than the one of the power sources such that a rate power supplied by the one of the power sources decreases.

2. The energy management system of claim 1, wherein the controller is further programmed to satisfy the demand for power from the building via the grid and the power sources such that as the demand for power from the building changes, a rate of power supplied by the grid to the building remains constant and greater than zero.

3. The energy management system of claim 2, wherein the controller is further programmed to satisfy the demand for power from the building via the grid and the power sources such that as the demand for power from the building changes, a rate of power supplied by the power sources to the building changes.

4. The energy management system of claim 1, wherein the controller is further programmed to, responsive to excess power generated by another of the power sources exceeding the demand for power from the building, transfer the excess power to the one of the power sources for storage.

5. The energy management system of claim 1, wherein the one of the power sources is an electric vehicle.

6. The energy management system of claim 1, wherein the power sources include an electric vehicle, a solar panel, or a battery.

7. A method comprising:
commanding a grid and at least one of a plurality of power sources to concurrently satisfy demand for power from a building such that as the demand for power from the building changes, a rate of power supplied by the grid to the building remains constant and greater than zero.

8. The method of claim 7 further comprising commanding the grid and the at least one of the plurality of power sources to concurrently satisfy the demand for power from the budling such that as the demand for power from the building changes, a rate of power supplied by the at least one of the power sources to the building changes.

9. The method of claim 7 further comprising transitioning from supply of power from the grid to the building to supply of power from one of the power sources to the building such that during the transition a rate of power supplied to the building remains constant.

10. The method of claim 9 further comprising after the transition, satisfying demand for power from the building via more than the one of the power sources such that a rate power supplied by the one of the power sources decreases.

11. The method of claim 7 further comprising, responsive to excess power generated by another of the power sources exceeding the demand for power from the building, transferring the excess power to the one of the power sources for storage.

12. The method of claim 7, wherein the power sources include an electric vehicle, a solar panel, or a battery.

13. An energy management control system comprising:
a controller programmed to satisfy a demand for power from a building via a grid and an electric vehicle such that as the demand for power from the building changes, a rate of power supplied by the grid to the building remains constant and greater than zero.

14. The energy management control system of claim 13 wherein the controller is further programmed to satisfy the demand for power from the building via the grid and the electric vehicle such that as the demand for power from the building changes, a rate of power supplied by the electric vehicle to the building changes.

15. The energy management control system of claim 13, wherein the controller is further programmed to transition from supply of power from the grid to the building to supply of power from the electric vehicle to the building such that during the transition a rate of power supplied to the building remains constant.

16. The energy management control system of claim 15, wherein the controller is further programmed to, after the transition, to satisfy demand for power from the building via the electric vehicle and other power sources such that a rate power supplied by the electric vehicle to the building decreases.

17. The energy management control system of claim 16, wherein the controller is further programmed to store excess power generated by the other of the power sources to the electric vehicle.

18. The energy management control system of claim 16, wherein the other power sources include a solar panel or a battery.
